(19) United States
(12) Patent Application Publication
(10) Pub. No.: US 2016/0136619 A1
(43) Pub. Date: May 19, 2016

(54) Cobalt Containing Bimetallic Zero PGM Catalyst for TWC Applications

(71) Applicants: Zahra Nazarpoor, Camarillo, CA (US); Oguzhan Selim Yaglidere, Moorpark, CA (US); Stephen J. Golden, Santa Barbara, CA (US)

(72) Inventors: Zahra Nazarpoor, Camarillo, CA (US); Oguzhan Selim Yaglidere, Moorpark, CA (US); Stephen J. Golden, Santa Barbara, CA (US)

(73) Assignee: CLEAN DIESEL TECHNOLOGIES, INC., Ventura, CA (US)

(21) Appl. No.: 14/543,485

(22) Filed: Nov. 17, 2014

(51) Int. Cl. B01J 23/75; B01J 23/00; B01J 23/889; B01J 35/00; B01J 23/10; B01J 23/745

(52) U.S. Cl. CPC B01J 23/75; B01J 23/10; B01J 23/745; B01J 23/8892; B01J 35/0006; B01J 23/005

(57) ABSTRACT

Variations of bulk powder catalyst material including Cu—Co, Fe—Co, and Co—Mn spinel systems for ZPGM TWC applications are disclosed. The disclosed bulk powder catalyst samples include stoichiometric and non-stoichiometric Cu—Co, Fe—Co, and Co—Mn spinels on Pr₆O₁₁—ZrO₂ support oxide, prepared using incipient wetness method. Activity measurements under isothermal steady state sweep test condition may be performed rich to lean condition. Catalytic activity of bulk powder samples may be compared to analyze the influence that different bimetallic spinel compositions may have on TWC performance, including ZPGM materials for a plurality of TWC applications. Stoichiometric Cu—Co, Fe—Co, and Co—Mn spinel systems exhibit higher catalytic activity than non-stoichiometric Cu—Co, Fe—Co, and Co—Mn spinel systems. The influence of stoichiometric Cu—Co, Fe—Co, and Co—Mn spinel systems may lead into cost effective manufacturing solutions for ZPGM TWC systems.

### CROSS-REFERENCE TO RELATED APPLICATIONS

N/A

### BACKGROUND

1. Field of the Disclosure

The present disclosure may provide Zero-PGM (ZPGM) catalyst materials, which may include stoichiometric or non-stoichiometric Co containing bimetallic spinel in the form of powder to use for three-way catalyst (TWC) applications.

2. Background Information

Air pollutants, such as NOx, CO, and HC from automobile exhaust should be removed as completely as possible from the combustion exit gases to avoid burdening the environment. Whereas power plant or motor vehicle emissions are being progressively curtailed with catalyst systems, there is a need for more effective Zero-PGM material compositions, capable of abating the pollutant fractions in motor vehicle exit of exhaust gases, which is becoming more important, especially with the increasing number of motor vehicles.

Many solutions have been proposed for catalyst conversion of NOx, CO, and HC emissions from motor vehicle engines. To diminish air pollutants levels. Catalyst materials may have to meet some catalyst requirements, including high conversion ratio at high and low temperatures, especially in the event of frequent load changes during operation, which is being accomplished by most of TWC systems.

TWC systems may include materials, which may be based on platinum group metals (PGMs), including Pt—Rh, Pt—Pd, Pd—Rh, among others, but may be desirable the use of cost effective material compositions for low manufacturing and operating costs, with high catalytic activities at all temperatures.

According to the foregoing reasons, there is a need of material compositions that does not require platinum group metals, and has similar o better efficiency as prior art catalysts, that can be used in a variety of environments for TWC applications, which can be manufactured cost-effectively. These materials may be capable to provide improved catalytic performance across a range of temperatures and operating conditions, while maintaining or even improving the catalytic activities under a variety of engine operating conditions.

### SUMMARY

The present disclosure may provide Zero-PGM (ZPGM) catalysts, which may include stoichiometric or non-stoichiometric variations of binary spinel systems including Co in its composition, on doped Zirconia support oxide in the form of powder, to develop suitable ZPGM catalysts for TWC applications.

According to embodiments in present disclosure, catalyst samples may be prepared using variations of Co—Cu, Co—Fe, and Co—Mn, stoichiometric and non-stoichiometric spinels on doped Zirconia support oxide, which may be converted into bulk powder format by incipient wetness (IW) method, as known in the art, of spinel systems aqueous solution on doped Zirconia support oxide powder. Stoichiometric or non-stoichiometric bimetallic spinel structures may be prepared at different molar ratios according to general formulation A_{X}B_{3-X}O₄, where X may be variable of different molar ratios within a range from about zero to about 1.0. In present disclosure, disclosed Co—Cu, Co—Fe, and Co—Mn spinel systems may be supported on Praseodymium-Zirconia support oxide powders, which may be subsequently dried, calcined, and ground to fine bulk powder.

Disclosed binary spinel systems including Co—Cu, Co—Fe, and Co—Mn in its composition, may be verified preparing bulk powder samples for each of the catalyst formulations and configurations, object of present disclosure, to determine its influence on TWC performance of ZPGM catalysts.

The NO/CO cross over R-value of bulk powder catalyst samples, per bimetallic spinel systems in present disclosure, may be determined by performing isothermal steady state sweep test. The isothermal steady state sweep test may be carried out at a selected inlet temperature using an 11-point R-value from rich condition to lean condition at a plurality of space velocities. Results from isothermal steady state sweep test may be compared to show the influence that different bimetallic spinel system bulk powders may have on TWC performance, particularly under rich condition close to stoichiometric condition. Additionally, catalytic performance of bulk powder samples including Co—Cu, Co—Fe, and Co—Mn spinels may be qualitatively compared separately for each group of bimetallic spinel systems. According to principles in present disclosure, the bimetallic spinel system in each group, which shows high level of activity, may be compared with bimetallic spinel systems from other groups also showing high level of activity to analyze influence on TWC performance for overall improvements on catalyst systems.

According to principles in present disclosure, comparison of ZPGM bulk powder catalyst samples including Co in its composition for improved catalytic performance for a plurality of TWC applications. Catalyst samples in the other groups, which may show significant TWC performance, may also be made available for utilization as bulk powder catalyst materials for the manufacturing of ZPGM catalysts for TWC applications.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 illustrates catalyst performance for bulk powder catalyst samples of stoichiometric Cu—Co spinel on doped Zirconia support oxide, under isothermal steady state sweep condition, at inlet temperature of about 450° C. and SV of about 40,000 h⁻¹, according to an embodiment.

FIG. 2 depicts catalyst performance comparison for bulk powder catalyst samples of stoichiometric and non-stoichiometric Cu—Co spinels on doped Zirconia support oxide, under isothermal steady state sweep condition, at inlet temperature of about 450° C. and SV of about 40,000 h⁻¹, according to an embodiment. FIG. 2A shows comparison of HC conversion levels for stoichiometric and non-stoichiometric Cu—Co spinels on doped Zirconia support oxide. FIG. 2B illustrates comparison of NOₓ conversion levels for stoichiometric and non-stoichiometric Cu—Co spinels on doped Zirconia support oxide.

FIG. 3 shows catalyst performance for bulk powder catalyst samples of stoichiometric Co—Fe spinel on doped Zirconia support oxide, under isothermal steady state sweep condition, at inlet temperature of about 450° C. and SV of about 40,000 h⁻¹, according to an embodiment.

FIG. 4 shows catalyst performance for bulk powder catalyst samples of stoichiometric Co—Mn spinel on doped Zirconia support oxide, under isothermal steady state sweep condition, at inlet temperature of about 450° C. and SV of about 40,000 h⁻¹, according to an embodiment.

FIG. 5 illustrates catalyst performance comparison for bulk powder catalyst samples of stoichiometric Cu—Co, Co—Fe and Co—Mn spinels on doped Zirconia support oxide, under isothermal steady state sweep condition, at inlet temperature of about 450° C. and SV of about 40,000 h⁻¹, according to an embodiment, and shows comparison of HC conversion levels for stoichiometric Cu—Co, Co—Fe and Co—Mn spinels on doped Zirconia support oxide and shows comparison of NOx conversion levels for stoichiometric Cu—Co, Co—Fe and Co—Mn spinels on doped Zirconia support oxide.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group Metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Incipient wetness” refers to the process of adding solution of catalytic material to a dry support oxide powder until all pore volume of support oxide is filled out with solution and mixture goes slightly near saturation point.

“Calcination” refers to a thermal treatment process applied to solid materials, in presence of air, to bring about a thermal decomposition, phase transition, or removal of a volatile fraction at temperatures below the melting point of the solid materials.

“Milling” refers to the operation of breaking a solid material into a desired grain or particle size.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or “A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

### DESCRIPTION OF THE DRAWINGS

The present disclosure provides a plurality of binary spinel bulk ZPGM powder material compositions including Co—Cu, Co—Fe and Co—Mn spinels, prepared at different molar ratios supported on doped-Zirconia support oxide, to develop suitable ZPGM catalyst materials capable of providing improved catalytic activities. Aspects that may be treated in present disclosure, may show improvements for overall catalytic conversion capacity for a plurality of ZPGM catalysts, which may be suitable for TWC applications.

Bulk Powder ZPGM Catalyst Material Composition and Preparation

In the present disclosure, Zero-PGM material compositions in form of bulk powder may be prepared from stoichiometric and non-stoichiometric bimetallic spinels of Co—Cu, Co—Fe and Co—Mn at different molar ratios. All bimetallic spinels may be supported on doped Zirconia support oxide, via incipient wetness (IW) method as known in the art.

Preparation of bulk powder catalyst samples may begin by preparing the bimetallic solution for Co—Cu, Co—Fe and Co—Mn spinels to make aqueous precursor solution. Bimetallic solutions of Co—Cu, Co—Fe and Co—Mn spinels may be prepared by mixing the appropriate amount of nitrate precursors of two elements to obtain the right composition, including Co nitrate solution Co(NO₃)₂, Cu nitrate solution (CuNO₃), Fe nitrate solution (Fe(NO₃)₃) or Mn nitrate solution (Mn(NO₃)₂). After mixing with water to make solution at different molar ratios, according to general formulations in Table 1, where disclosed bimetallic spinel systems in present disclosure are shown. Accordingly, solution of Cu—Co, Co—Fe, and Co—Mn nitrates may be subsequently added drop-wise to doped Zirconia powder via IW method. Then, mixtures of Cu—Co, Co—Fe, and Co—Mn bimetallic spinels on doped Zirconia support oxide may be dried at 120 C over night and calcined at about 800° C. for about 5 hours. Subsequently, calcined materials of Cu—Co, Co—Fe, and Co—Mn bimetallic spinels on doped Zirconia may be ground to fine grain bulk powder for preparation of catalyst samples.

TABLE 1

| SYSTEM | ELEMENTS | COMPOSITION | |
|---|---|---|---|
| BINARY | Cu—Co | CuₓCo₃₋ₓO₄ | 0 ≦ X ≦ 1 |
| | Co—Fe | FeₓCo₃₋ₓO₄ | 0 ≦ X ≦ 1 |
| | Co—Mn | CoₓMn₃₋ₓO₄ | 0 ≦ X ≦ 1 |

Bulk powder catalyst samples may be prepared for testing under isothermal steady state sweep condition to determine and analyze TWC performance resulting for each catalyst sample including stoichiometric and non-stoichiometric Cu—Co, Co—Fe, and Co—Mn bimetallic spinels on doped Zirconia support oxide.

The NO/CO cross over R-value of bulk powder catalyst samples, per disclosed bimetallic spinels, may be determined by performing isothermal steady state sweep test.

Results from isothermal steady state sweep test may be compared to show the influence that different bimetallic spinel system bulk powders may have on TWC performance, particularly under rich condition close to stoichiometric condition at a selected R-value. Additionally, catalytic performance of bulk powder samples including stoichiometric and non-stoichiometric Cu—Co, Co—Fe, and Co—Mn spinels on doped Zirconia support oxide may be qualitatively compared.

According to principles in present disclosure, the bimetallic spinel system in each group, which shows high level of activity, may be compared with bimetallic spinel systems from other groups also showing high level of activity to analyze influence on TWC performance for overall improvements that may be developed in the preparation of bulk powder catalyst materials to use ZPGM catalyst for TWC applications.

Isothermal Steady State Sweep Test Procedure

The isothermal steady state sweep test may be done employing a flow reactor at inlet temperature of about 450° C., and testing a gas stream at 11-point R-values from about 2.0 (rich condition) to about 0.8 (lean condition) to measure the CO, NO, and HC conversions. In present disclosure, gas stream may be tested at R-values from about 1.6 (rich condition) to about 0.9 (lean condition) to measure the CO, NO, and HC conversions.

The space velocity (SV) in the isothermal steady state sweep test may be adjusted at about 40,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, about 10% of CO₂, and about 10% of H₂O. The quantity of O₂ in the gas mix may be varied to adjust Air/Fuel (A/F) ratio within the range of R-values to test the gas stream.

The following examples are intended to illustrate, but not to limit the scope of the present disclosure.

It is to be understood that other procedures known to those skilled in the art may alternatively be used.

### EXAMPLES

### Example #1

### Stoichiometric and Non-Stoichiometric Cu—Co Spinels on Pr₆O₁₁—ZrO₂ Support Oxide

Example #1 may illustrate preparation of bulk powder catalyst samples from stoichiometric and non-stoichiometric Cu—Co spinels supported on Pr₆O₁₁—ZrO₂ support oxide via IW method, according to a plurality of molar ratios, as shown in Table 2, based in general formulation CuₓCo₃₋ₓO₄, where X may be variable of different molar ratios within a range of about 0≦X≦1.

Preparation of bulk powder catalyst samples may begin by preparing the Cu—Co solution to make aqueous solution. Cu—Co solution may be prepared by mixing the appropriate amount of Cu nitrate solution (CuNO₃) and Co nitrate solution Co(NO₃)₂ with water to make solution at different molar ratios according to formulation in Table 2, where disclosed stoichiometric and non-stoichiometric Cu—Co spinel systems are shown. Then, solution of Cu—Co nitrates may be added drop-wise to Pr₆O₁₁—ZrO₂ support oxide powder via IW method. Subsequently, mixture of Cu—Co spinel on Pr₆O₁₁—ZrO₂ support oxide may be dried at 120 C over night and calcined at about 800° C. for about 5 hours, and then ground to fine grain bulk powder.

TABLE 2

| BINARY SPINEL | COMPOSITION |
|---|---|
| Cu—Co | Cu_{1.0}Co_{2.0}O₄ |
| | Cu_{0.5}Co_{2.5}O₄ |
| | Cu_{0.2}Co_{2.8}O₄ |
| | Co₃O₄ |

In example #1, performance of bulk powder catalyst samples may be determined by performing isothermal steady state sweep test at about 450° C., and testing a gas stream at R-values from about 2.0 (rich condition) to about 0.8 (lean condition) to measure the CO, NO, and HC conversions. SV in the isothermal steady state sweep test may be adjusted at about 40,000 h⁻¹. In present disclosure, NO conversion, CO conversion, and HC conversion from prepared bulk powder samples of stoichiometric and non-stoichiometric Cu—Mn spinels may be measured/analyzed from about 1.6 (rich condition) to about 0.9 (lean condition).

Catalytic Performance of Cu—Co Spinel Catalyst

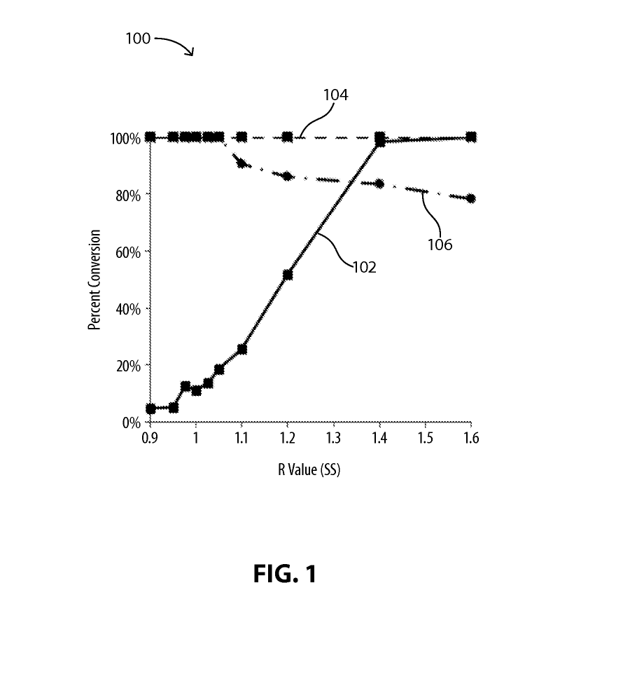

FIG. 1 illustrates catalyst performance 100 for bulk powder catalyst samples prepared per example #1, according to composition from Table 2, under isothermal steady state sweep condition, at inlet temperature of about 450° C. and SV of about 40,000 h⁻¹, according to an embodiment.

In FIG. 1, conversion curve 102 (solid line with square), conversion curve 104 (dash line with square), and conversion curve 106 (dash and dotted line with circle) respectively illustrate isothermal steady state sweep test results for NO conversion, CO conversion, and HC conversion for bulk powder catalyst samples, including stoichiometric Cu_{1.0}Co_{2.0}O₄ spinel.

As may be seen in FIG. 1, for bulk powder catalyst samples including stoichiometric Cu_{1.0}Co_{2.0}O₄ spinel, NO/CO cross over R-value takes place at the specific R-value of 1.40 (rich condition), where NOₓ and CO conversions is about 98.3%. The sweep test results shows that CO and HC conversion is about 100% at lean and stoichiometric condition with R-value but HC conversion start to decrease after R-value>1.05. It may be also noted that higher NOₓ conversion may be due to the presence of Cu in the spinel structure, and high HC conversion may be due to presence of Co in the spinel structure.

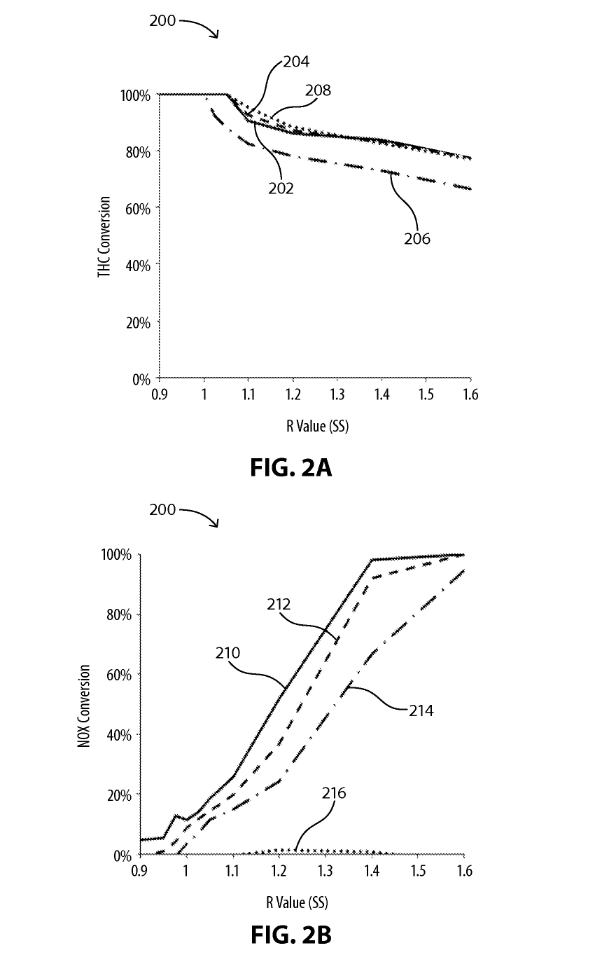

FIG. 2 depicts catalyst performance comparison 200 for bulk powder catalyst samples per example #1, according to molar ratio composition from Table 2, under isothermal steady state sweep condition, at inlet temperature of about 450° C. and SV of about 40,000 h⁻¹, according to an embodiment.

In FIG. 2A, conversion curve 202 (solid line), conversion curve 204 (dash line), conversion curve 206 (dot and dash line), and conversion curve 208 (dotted line) respectively illustrates sweep test results for HC conversion of bulk powder catalyst samples including Cu_{1.0}Co_{2.0}O₄, Cu_{0.5}Co_{2.5}O₄, Cu_{0.2}Co_{2.8}O₄ and Co₃O₄ spinels. Sweep test results shows the HC conversion is similar for different compositions, however, Cu_{0.2}Co_{2.8}O₄ shows lower conversion compare to the rest of samples. It may be noted that Co₃O₄ spinel shows a higher level of HC conversion, which confirms high activity of Co oxide in HC conversion. CO conversion (not shown here) is 100% for all samples in whole range of R-values.

In FIG. 2B, conversion curve 210 (solid line), conversion curve 212 (dash line), conversion curve 214 (dot and dash line) and conversion curve 216 (dotted line) respectively depict sweep test results for NO conversion comparison for bulk powder catalyst samples including Cu_{1.0}Co_{2.0}O₄, Cu_{0.5}Co_{2.5}O₄, Cu_{0.2}Co_{2.8}O₄ and Co₃O₄ spinels. Sweep test results of NOₓ conversion for bulk powder catalyst samples including stoichiometric Cu_{1.0}Co_{2.0}O₄ spinel, shows higher level of activity for NOx conversion. It may be also noted that by decreasing the amount of Cu in formula CuₓCo₁₋ₓO₄ to x<1.0, the NOx conversion decrease. Lower NOₓ conversion may be due to the absence of Cu in the spinel structure, including Co₃O₄ spinel, where (Cu=0).

### Example #2

### Stoichiometric and Non-Stoichiometric Fe—Co Spinels on Pr₆O₁₁—ZrO₂ Support Oxide

Example #2 may illustrate preparation of bulk powder catalyst samples from stoichiometric and non-stoichiometric Co—Fe spinels supported on Pr₆O₁₁—ZrO₂ support oxide via IW method, with molar ratios according to formulation FeₓFCo₃₋ₓO₄, where X may be variable of different molar ratios within a range of about 0≦X≦1.

Preparation of bulk powder catalyst samples may begin by preparing the Co—Fe solution to make aqueous solution. Co—Fe solution may be prepared by mixing the appropriate amount of Co nitrate solution Co(NO₃)₂ and Fe nitrate solution (Fe(NO₃)₃) with water to make solution at different molar ratios according to formulation in Table 3, where disclosed stoichiometric and non-stoichiometric Co—Fe spinel systems are shown. Then, solution of Co—Fe nitrates may be added drop-wise to Pr₆O₁₁—ZrO₂ support oxide powder via IW method. Subsequently, mixture of Co—Fe spinel on Pr₆O₁₁—ZrO₂ support oxide may be dried at 120 C over night and calcined at about 800° C. for about 5 hours, and then ground to fine grain bulk powder.

TABLE 3

| BINARY SPINEL | COMPOSITION |
|---|---|
| Co—Fe | Fe_{1.0}Co_{2.0}O₄ |
| | Fe_{0.6}Co_{2.4}O₄ |
| | Fe_{0.3}Co_{2.7}O₄ |

In example #2, the performance of bulk powder catalyst samples may be determined by performing isothermal steady state sweep test at about 450° C., and testing a gas stream at R-values from about 2.0 (rich condition) to about 0.8 (lean condition) to measure the CO, NO, and HC conversions. SV in the isothermal steady state sweep test may be adjusted at about 40,000 h⁻¹. In present disclosure, NO conversion, CO conversion, and HC conversion from prepared bulk powder samples of stoichiometric and non-stoichiometric Co—Fe spinels may be measured/analyzed from about 1.6 (rich condition) to about 0.9 (lean condition).

Catalytic Performance of Fe—Co Spinel Catalyst

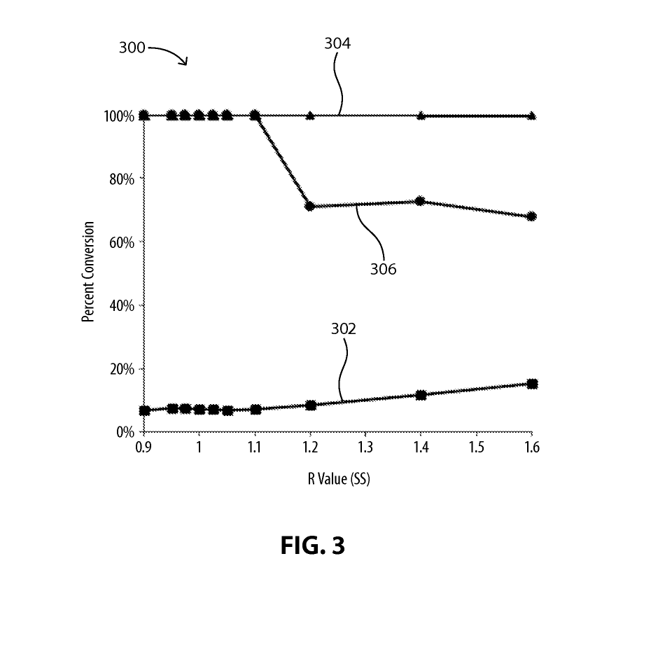

FIG. 3 shows catalyst performance 300 for bulk powder catalyst samples prepared per example #2, according to composition from Table 3 under isothermal steady state sweep condition, at inlet temperature of about 450° C. and SV of about 40,000 h⁻¹, according to an embodiment.

In FIG. 3, conversion curve 302 (solid line with square), conversion curve 304 (solid line with triangle), and conversion curve 306 (solid line with circle) respectively show isothermal steady state sweep test results for NO conversion, CO conversion, and HC conversion for bulk powder catalyst samples, including stoichiometric Fe_{1.0}Co_{2.0}O₄ spinel as example of NOx catalytic behavior.

As may be seen in FIG. 3, sweep test results for bulk powder catalyst samples including stoichiometric Fe_{1.0}Co_{2.0}O₄ spinel, NO/CO cross over R-value does not occur. Activity for bulk powder samples including stoichiometric Fe_{1.0}Co_{2.0}O₄ spinel shows a very high level of activity for CO and HC conversion with 100% conversion for lean and stoichiometric condition, while HC conversion decrease after R-value>1.1. NOx conversion remains low with slight increase for R-values>1.1.

May be observed in formula FeₓCo₃₋ₓO₄ by increasing Co content (x<1.0), the NOx conversion activities decrease.

### Example #3

### Stoichiometric and Non-Stoichiometric Co—Mn Spinels on Pr₆O₁₁—ZrO₂ Support Oxide

Example #3 may illustrate preparation of bulk powder catalyst samples from stoichiometric and non-stoichiometric Co—Mn spinels supported on Pr₆O₁₁—ZrO₂ support oxide via IW method, with molar ratios according to formulation CoₓMn₃₋ₓO₄, where X may be variable of different molar ratios within a range of about 0≦X≦1.

Preparation of bulk powder catalyst samples may begin by preparing the Co—Mn solution to make aqueous solution. Co—Mn solution may be prepared by mixing the appropriate amount of Co nitrate solution Co(NO₃)₂ and Mn nitrate solution (Mn(NO₃)₂) with water to make solution at different molar ratios according to formulation in Table 4, where disclosed stoichiometric and non-stoichiometric Co—Mn spinel systems are shown. Then, solution of Co—Mn nitrates may be added to Pr₆O₁₁—ZrO₂ support oxide powder via IW method. Subsequently, mixture of Co—Mn spinel on Pr₆O₁₁—ZrO₂ support oxide may be dried at 120 C over night and calcined at about 800° C. for about 5 hours, and then ground to fine grain bulk powder.

TABLE 4

| Binary Spinel | Composition |
|---|---|
| Co—Mn | Co_{1.0}Mn_{2.0}O₄ |
| | Co_{0.6}Mn_{2.4}O₄ |
| | Co_{0.3}Mn_{2.7}O₄ |

In example #3, the performance of bulk powder catalyst samples may be determined by performing isothermal steady state sweep test at about 450° C., and testing a gas stream at R-values from about 2.0 (rich condition) to about 0.8 (lean condition) to measure the NO, CO, and HC conversions. SV in the isothermal steady state sweep test may be adjusted at about 40,000 h⁻¹. In present disclosure, NO conversion, CO conversion, and HC conversion from prepared bulk powder samples of stoichiometric and non-stoichiometric Co—Mn spinels may be measured/analyzed from about 1.6 (rich condition) to about 0.9 (lean condition).

Catalytic Performance of Co—Mn Spinel Catalyst

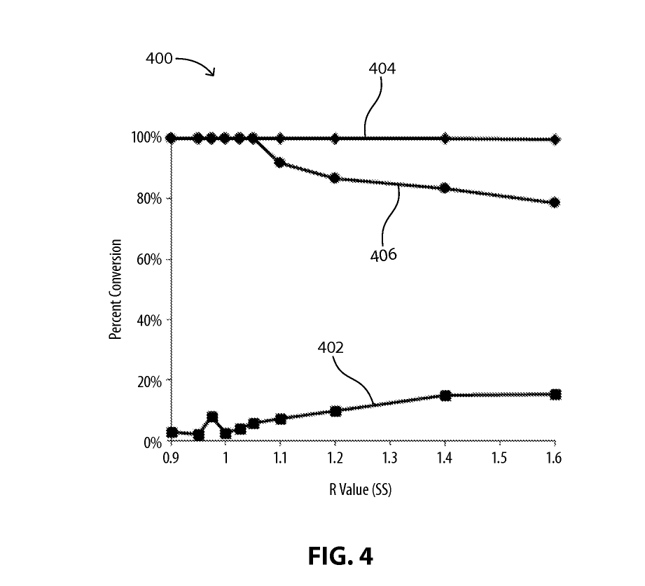

FIG. 4 shows catalyst performance 400 for bulk powder catalyst samples prepared per example #3, according to composition from Table 4, under isothermal steady state sweep condition, at inlet temperature of about 450° C. and SV of about 40,000 h⁻¹, according to an embodiment.

In FIG. 4, conversion curve 402 (solid line with square), conversion curve 404 (solid line with diamond), and conversion curve 406 (solid line with circle) respectively show isothermal steady state sweep test results for NO conversion, CO conversion, and HC conversion for bulk powder catalyst samples including stoichiometric Co_{1.0}Mn_{2.0}O₄ spinel as example of NOx catalytic behavior.

As may be seen in FIG. 4, for bulk powder catalyst samples including stoichiometric Co_{1.0}Mn_{2.0}O₄ spinel, NO/CO cross over R-value does not occur. Activity for bulk powder samples including stoichiometric Co_{1.0}Mn_{2.0}O₄ spinel may be observed at R-value of 1.2. At this R-value, NOₓ, CO, and HC conversions are about 9.7%, 99.8% and 86.6%, respectively. The lower NOₓ conversion activity may be due to the absence of Cu in the spinel structure.

It may be noted an overall lower level of NOₓ conversion activity for Co_{1.0}Mn_{2.0}O₄ spinel system. It may be also noted in CoₓMn₃₋ₓO₄, by increasing Mn, x<1.0, the NOx conversion activity decrease. However, there is an improved level of CO activities with 100% conversion, and also a good level of HC conversion activity for Co_{1.0}Mn_{2.0}O₄ spinel system.

Bulk powder catalyst materials including stoichiometric and non-stoichiometric Co—Mn spinel may be employed as oxidation catalyst material for high level of HC/CO conversion.

Comparison of ZPGM catalyst performance for bimetallic systems with stoichiometric structure

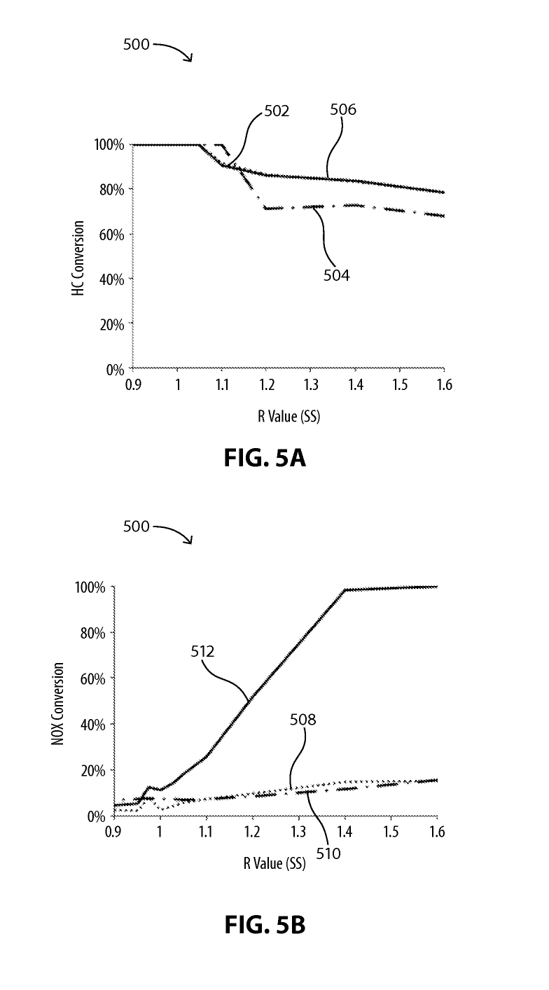

FIG. 5 illustrate catalyst performance comparison 500 for bulk powder catalyst samples prepared per example #1, example #2, and example #3 respectively, under isothermal steady state sweep condition, at inlet temperature of about 450° C. and SV of about 40,000 h⁻¹, according to an embodiment.

In FIG. 5A, conversion curve 502 (dotted line), conversion curve 504 (dot and dash line), conversion curve 506 (solid line) respectively illustrate isothermal steady state sweep test results for HC conversion comparison for bulk powder catalyst samples including stoichiometric Cu_{1.0}Co_{2.0}O₄, Fe_{1.0}Co_{2.0}O₄, and Co_{1.0}Mn_{2.0}O₄ spinels. As may be seen, comparison of results of HC conversion indicates that bulk powder catalyst samples including stoichiometric Cu_{1.0}Co_{2.0}O₄ spinel and Co_{1.0}Mn_{2.0}O₄ shows higher level of catalytic activity than bulk powder catalyst samples including stoichiometric Fe_{1.0}Co_{2.0}O₄ spinels.

In FIG. 5B, conversion curve 512 (solid line), conversion curve 510 (dot and dash line), and conversion curve 508 (dotted line) respectively depict steady state sweep test results for NO conversion comparison for bulk powder catalyst samples including Cu_{1.0}Co_{2.0}O₄, Fe_{1.0}Co_{2.0}O₄, and Co_{1.0}Mn_{2.0}O₄ spinels. A comparison of test results of NOₓ conversion indicates that bulk powder catalyst samples including stoichiometric Cu_{1.0}Co_{2.0}O₄ spinel shows higher catalytic activities than bulk powder catalyst samples including stoichiometric Fe_{1.0}Co_{2.0}O₄, and Co_{1.0}Mn_{2.0}O₄ spinels, indicating that bimetallic bulk powder catalyst samples without Cu in its composition does not exhibit acceptable level of NOx conversion.

In present disclosure, may be observed that stoichiometric and non-stoichiometric bimetallic Cobalt spinel systems not including Cu in its composition may show low or no NOₓ conversion activity. Cu may be the main element influencing improved NOₓ conversion. Additionally, in bimetallic systems including stoichiometric spinel formulation (A_{1.0}B_{2.0}O₄) shows improved levels of catalytic activities than non-stoichiometric spinels, including all combinations of bimetallic spinel system.

Bulk powder catalyst materials, including stoichiometric and non-stoichiometric Co—Mn spinel may be employed as oxidation catalyst material for HC/CO activities. Also, bulk powder catalyst samples including stoichiometric Cu—Co spinel exhibits higher NOₓ conversion activities than bulk powder catalyst samples including non-stoichiometric Fe—Co and Mn—Co spinel. It may also be noted in present disclosure that CO conversion is about 100% for all disclosed stoichiometric and non-stoichiometric bimetallic spinel systems.

Bulk powder catalyst samples, including stoichiometric Cu—Co on Pr₆O₁₁—ZrO₂ support oxide powder, may exhibit improved TWC performance activity when employed in ZPGM catalyst systems for a plurality of TWC applications, leading to a more effective utilization of ZPGM catalyst materials in TWC converters.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic composition, comprising:
an oxygen storage material, comprising:
a binary spinel on a doped zirconia support oxide;
wherein the oxygen storage material converts at least one of NO, CO and HC through oxidation or reduction.

2. The composition of claim 1, wherein the binary spinel is stoichiometric.

3. The composition of claim 1, wherein the binary spinel is non-stoichiometric.

4. The composition of claim 1, wherein the binary spinel comprises Co.

5. The composition of claim 1, wherein the general formula for the binary spinel is selected from the group consisting of Co—Cu, Co—Fe, and Co—Mn.

6. The composition of claim 1, wherein the general formula for the binary spinel is A_{X}B_{3-X}O₄, wherein 0<X>1.

7. The composition of claim 1, wherein the general formula for the binary spinel is selected from the group consisting of CuₓCo₃₋ₓO₄, FeₓCO₃₋ₓO₄ and CoₓMn₃₋ₓO₄.

8. The composition of claim 1, wherein the binary spinel is combined with the support oxide by incipient wetness (IW) method.

9. A catalytic composition, comprising:
an oxygen storage material, comprising:
a ternary spinel on a doped zirconia support oxide;
wherein the oxygen storage material converts at least one of NO, CO and HC through oxidation or reduction.

10. The composition of claim 9, wherein the ternary spinel is stoichiometric.

11. The composition of claim 9, wherein the ternary spinel is non-stoichiometric.

12. The composition of claim 9, wherein the ternary spinel comprises Co.

13. The composition of claim 9, wherein the general formula for the ternary spinel is CuₓCo₁₋ₓO₄, wherein 0≦x<1.0

14. The composition of claim 9, wherein the general formula for the ternary spinel is FeₓCo₃₋ₓO₄, wherein 0<x<1.0

15. The composition of claim 9, wherein the general formula for the ternary spinel is CoₓMn₃₋ₓO₄, wherein 0<x<1.0

16. The composition of claim 9, wherein the ternary spinel is combined with the support oxide by incipient wetness (IW) method.
